(19) United States
(12) Patent Application Publication
(10) Pub. No.: US 2007/0246100 A1
(43) Pub. Date: Oct. 25, 2007

(54) Exhaust port protective device for an air valve

(75) Inventors: Charles E. Stephens, Seattle, WA (US); David Edwards, Port Orchard, WA (US)

Correspondence Address: THE OLLILA LAW GROUP LLC, 2060 BROADWAY, SUITE 300, BOULDER, CO, 80302, US

(73) Assignee: GT Development Corporation, Seattle, WA (US)

(21) Appl. No.: 11/407,871

(22) Filed: Apr. 19, 2006

(51) Int. Cl. F16K 27/08

(52) U.S. Cl. 137/382

(57) ABSTRACT

In a valve assembly (18) of the type having a housing, a pole piece (16) disposed within the housing, and an exhaust port (50), one embodiment of an exhaust port protective device (10) comprises a flow restrictor assembly coupled at least in part to the pole piece (16). The flow restrictor assembly provides fluid flow in a first direction and restricts fluid flow in a second direction.

### TECHNICAL FIELD

The present disclosure relates generally to protective valve port coverings and, more specifically, to an exhaust port protective device for an air valve.

### BACKGROUND

Solenoid-actuated air valves provide a mechanism for electronically controlling the flow of air in various pneumatic systems. A solenoid air valve may include an air supply port, a delivery port, and an exhaust port. The solenoid air valve is coupled to a pneumatic subsystem or accessory and the valve delivers air to the pneumatic subsystem or accessory through the delivery port. Excess air in the pneumatic subsystem or accessory is exhausted through the exhaust port.

If moisture enters the solenoid air valve through the exhaust port, the internal components of the air valve can become corroded and the air valve ceases to function properly. Thus, it is desirable to protect the exhaust port by a covering or protective device that minimizes foreign objects from entering the exhaust port without significantly impeding the escape of air from the solenoid air valve.

### SUMMARY

One embodiment of an exhaust port protective device formed in accordance with the present disclosure is used with a valve assembly of the type having a housing, a pole piece disposed within the housing, and an exhaust port. The exhaust port protective device comprises a flow restrictor assembly coupled at least in part to the pole piece. The flow restrictor assembly provides fluid flow in a first direction and restricts fluid flow in a second direction.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this application will become better understood by reference to the following detailed description, when taken in conjunction with the accompanying drawings, wherein:

FIG. 1 is an isometric view of a solenoid air valve with an exhaust port, wherein an exhaust port protective device constructed in accordance with one embodiment of the present disclosure is coupled to the exhaust port;

FIG. 2 is a cross-sectional side planar view of the solenoid air valve and exhaust port protective device of FIG. 1, taken substantially through section 2-2;

FIG. 3 is an isometric view of an exhaust shield cover;

FIG. 4 is an isometric view of a portion of the exhaust port protective device;

FIG. 5A is an isometric view of a first alternate embodiment of an exhaust port protective device coupled to a pole piece;

FIG. 5B is a cross-sectional side planar view of the first alternate embodiment of an exhaust port protective device coupled to the pole piece of FIG. 6A, taken substantially through section 5B-5B;

FIG. 6A is an isometric view of a second alternate embodiment of an exhaust port protective device coupled to a pole piece;

FIG. 6B is a cross-sectional side planar view of the second alternate embodiment of an exhaust port protective device coupled to the pole piece of FIG. 7A, taken substantially through section 6B-6B;

FIG. 7A is an isometric rear view of a third alternate embodiment of an exhaust port protective device;

FIG. 7B is a cross-sectional side planar view of the third alternate embodiment of an exhaust port protective device of FIG. 7A coupled to a pole piece;

FIG. 8A is an isometric view of a fifth alternate embodiment of an exhaust port protective device coupled to a pole piece;

FIG. 8B is cross-sectional side planar view of the exhaust port protective device and pole piece of FIG. 8A, taken substantially through section 10B-8B;

FIG. 8C is a top isometric view of the exhaust port protective device of FIG. 8A; and

FIG. 8D is a bottom isometric view of the housing of the exhaust port protective device of FIG. 8A.

### DETAILED DESCRIPTION

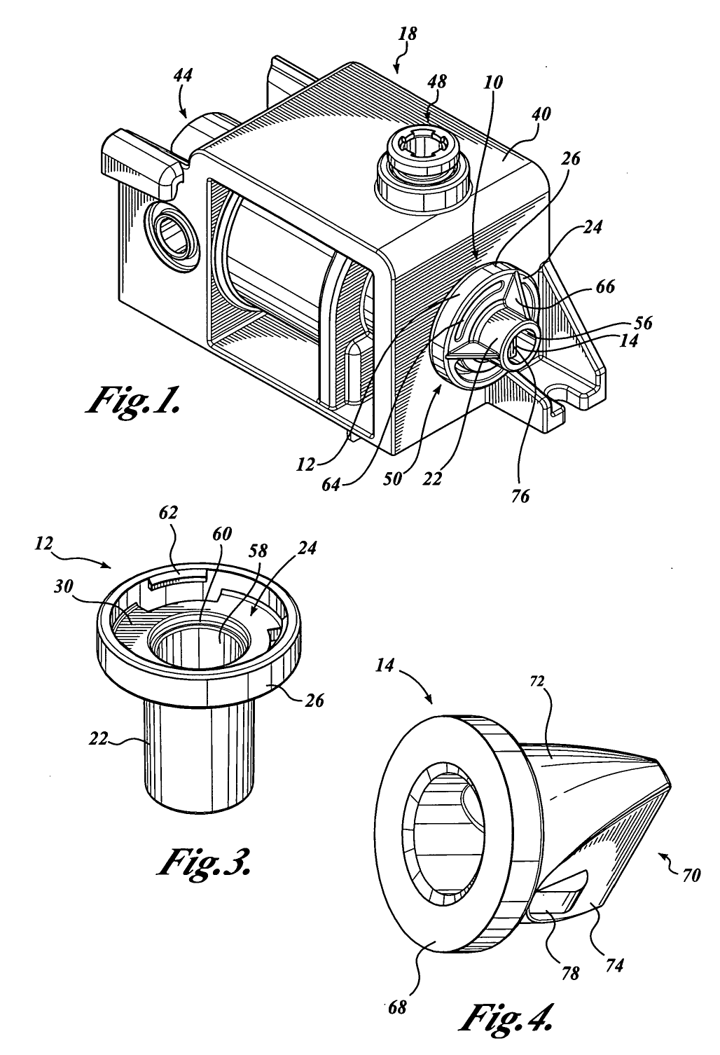

Referring to FIGS. 1-4, one embodiment of an exhaust port protective device 10 for an air valve includes a flow restrictor assembly providing fluid flow in a first direction and restricting fluid flow in a second direction. The flow restrictor assembly includes an exhaust shield cover 12 that receives a one-way valve 14. The exhaust shield cover 12 snaps onto a pole piece 16 of a solenoid air valve 18 to prevent the ingress of contamination into the solenoid air valve 18. The solenoid valve 18 is coupled to a pneumatic subsystem or accessory (not shown). Although the exhaust port protective device 10 is shown with a solenoid air valve 18, it should be appreciated that the exhaust port protective device 10 may be similarly used to protect the ports of other air valves.

Referring to FIGS. 1 and 2, although any solenoid air valve may be used without departing from the spirit and scope of the present disclosure, the solenoid air valve 18 includes an air supply port 44, a delivery port 48, and an exhaust port 50 that are in communication with each other via a central chamber 36. Disposed coaxially within central chamber 36 is moveable armature 32 and a pole piece 16, wherein the pole piece 16 is situated adjacent the exhaust port 50. The magnetic pole piece 16 includes a central bore 52 that is in communication with an opening in the exhaust port 50. Excess air in the solenoid valve 18 is exhausted through the exhaust port 50.

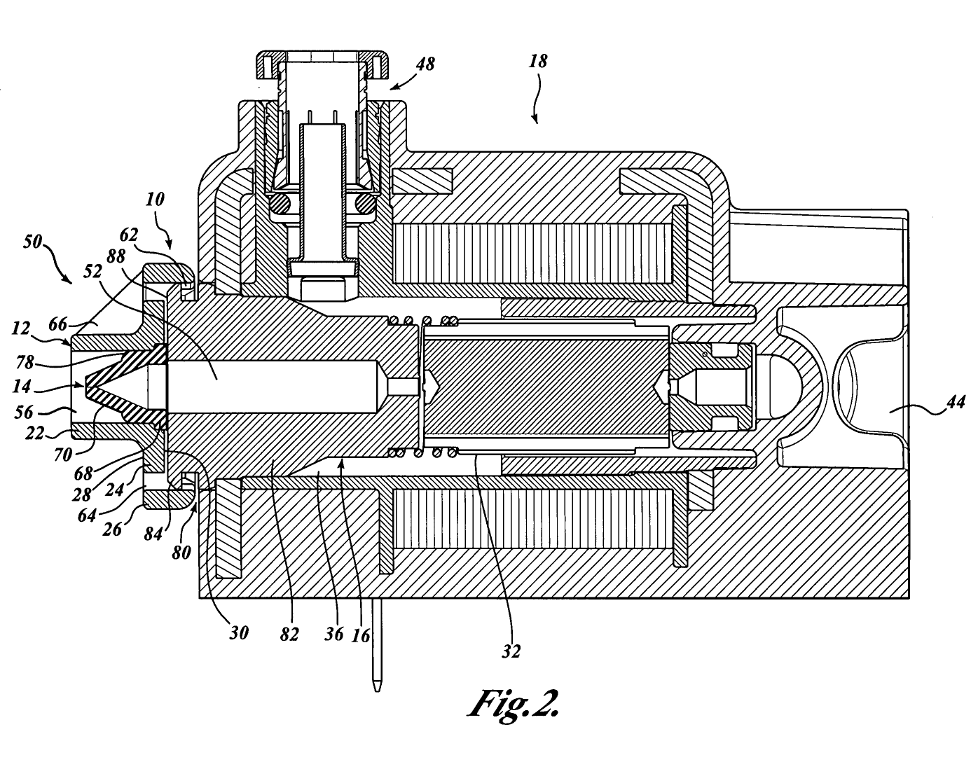

Still referring to FIG. 2, the exhaust port protective device 10 is coupled to the exposed end of the pole piece 16 to form the exhaust port 50. Referring to FIG. 3, the exhaust port protective device 10 includes a molded plastic exhaust shield cover 12 with a base 24 and an extension tube 22. The circular base 24 includes a base outer surface 28 and a base inner surface 30. An annular protrusion 26 is formed around the perimeter of the base 24 on the base inner surface 30. The annular protrusion 26 may include at least two, but preferably three, tapered tabs 62 protruding inwardly toward the center of the base 24.

A circular aperture 58 is formed in substantially the center of the base 24, and a counterbore 60 is formed coaxially within the circular aperture 58 on the base inner surface 30 is a counterbore 60. A plurality of curved slots 64 is formed within the base 24, each curved slot 64 conforming to the circular shape of the base 24 and spaced circumferentially about the base 24. Preferably, three slots 64 are formed within the base 24 and are spaced equidistant from one another around the circular aperture 58.

A cylindrical extension tube 22 extends outwardly from the base outer surface 28 in a substantially orthogonal manner in the center of the base 24. The extension tube 22 includes a longitudinal cylindrical opening 56 that is in fluid communication with the circular aperture 58 of the base 24. The extension tube 22 is supported on its external cylindrical surface by a plurality of gusset supports 66. The gusset supports 66 are triangular-shaped, with a first edge of the supports 66 engaging the base outer surface 28, and a second edge of the gusset supports 66 engaging the extension tube 22. Preferably, three supports 66 are formed on the exhaust shield cover 12 and are spaced equidistant from one another around the extension tube 22, each gusset support 66 being positioned between slots 64 on the base outer surface 28. It can also be appreciated that the exhaust shield cover 12 may be formed without gusset supports 66.

Preferably, the base 24, annular protrusion 26, extension tube 22, and gusset supports 66 are formed together as one piece. Any suitable method of forming the exhaust port protection device 10 may be used, such as plastic molding. However, it should be appreciated by one in the art that the base 24, annular protrusion 26, extension tube 22, and gusset supports 66 may instead be formed separately and thereafter mated together.

Now referring to FIG. 4, the exhaust port protective device 10 includes a molded one-way valve 14. The one-way valve 14 may be any standard flexible rubber one-way valve; however, the VERNAY VL2413-101 check valve is preferred. The one-way valve 14 is molded from a flexible rubber material and it includes a flange 68 and a valve portion 70. The valve portion 70 includes a hollow cylindrical body 72 that projects upwardly from the flange 68. Two opposing slanted walls 74 formed in the hollow cylindrical body 72 converge toward an elongated slit, or valve opening 76. A projection 78 is formed on each slanted wall 74 that may abut the inside surface of the extension tube 22 when the one way valve 14 is received therewithin. The flange 68 positioned at the end of the hollow cylindrical body 72 extends radially outwardly from the walls of the hollow cylindrical body 72.

Referring back to FIG. 2, the extension tube 22 of the exhaust shield cover 12 receives the one-way valve 14 to cooperatively form the exhaust port protective device 10. The valve portion 70 of the one-way valve 14 is received into the circular aperture 58 of the base 24, and it extends partially into the central opening 56 of the extension tube 22. The hollow cylindrical body 72 of the one-way valve 14 is substantially the same shape and size as the central opening 56 of the extension tube 22. Moreover, the projections 78 abut the inside surface of the extension tube 22 to center the valve portion 70 within the central opening 56 and provide stability to the one-way valve 14. It should be appreciated that the one-way valve 14 may also be formed without the projections 78.

The flange 68 of the one-way valve 14 is received into the counterbore 60 formed on the base inner surface 30 and the circular end portion of the flange 68 protrudes out of the counterbore 60 so that the end surface of the flange 68 engages the end surface 88 of the pole piece 16 when the exhaust port protective device 10 is coupled to the pole piece 16. The protruding end portion of flange 68 forms a seal around the opening of the central bore 52.

The magnetic pole piece 16 includes an annular groove 80 formed around the pole piece enlarged end 82. The annular groove 80 defines an exposed annular projection 84 that protrudes out of the solenoid air valve 18 when the pole piece 16 is mounted within. The exhaust port protective device 10 is coupled to the pole piece 16 by urging the housing tabs 62 over the exposed annular projection 84 and into the annular groove 80. The tabs 62 are tapered to reduce the force needed to urge the tabs 62 into the annular groove 80; however, once the exhaust port protective device 10 is coupled to the pole piece 16, it cannot easily be removed.

The solenoid air valve 18 is coupled to a pneumatic subsystem or accessory (not shown) through the delivery port 48. The excess air from the pneumatic subsystem or accessory is exhausted through the exhaust port 50 of the solenoid air valve 18; and therefore, air passes through the exhaust port protective device 10. In zero flow conditions the valve opening 76 of the one-way valve 14 remains closed. As the flow in the solenoid air valve 18 increases, the pressure on the slanted walls 74 increases and the one-way valve 14 opens. The exhaust port protective device 10 protects the solenoid valve 18 from ingress of contamination at the exhaust port 50 while at the same time not significantly impeding the escape of air.

If moisture enters the solenoid air valve 18 through the exhaust port 50, the internal components of the air valve 18 become corroded, causing the valve to “stick” in a first or second position or to otherwise cease functioning properly. The exhaust port protective device 10 prevents contamination from entering the exhaust port 50. The extension tube 22 acts as a stiffener for the one-way valve 14 and substantially prevents the one-way valve 14 from bending or opening when it is being sprayed with contamination. As shown in FIG. 2, the interior of the extension tube 22 engages the hollow cylindrical body 72 of the one-way valve 14 to provide the one-way valve 14 with stability and maintain its position. Moreover, the projections 78 abut the inside surface of the extension tube 22 to increase the stability of the one-way valve 14. In addition, the extension tube 22 substantially stops moisture from entering the valve opening 76 of the one-way valve 14 by deflecting the spray of contamination from angles of impingement that would normally cause the one-way valve 14 to open.

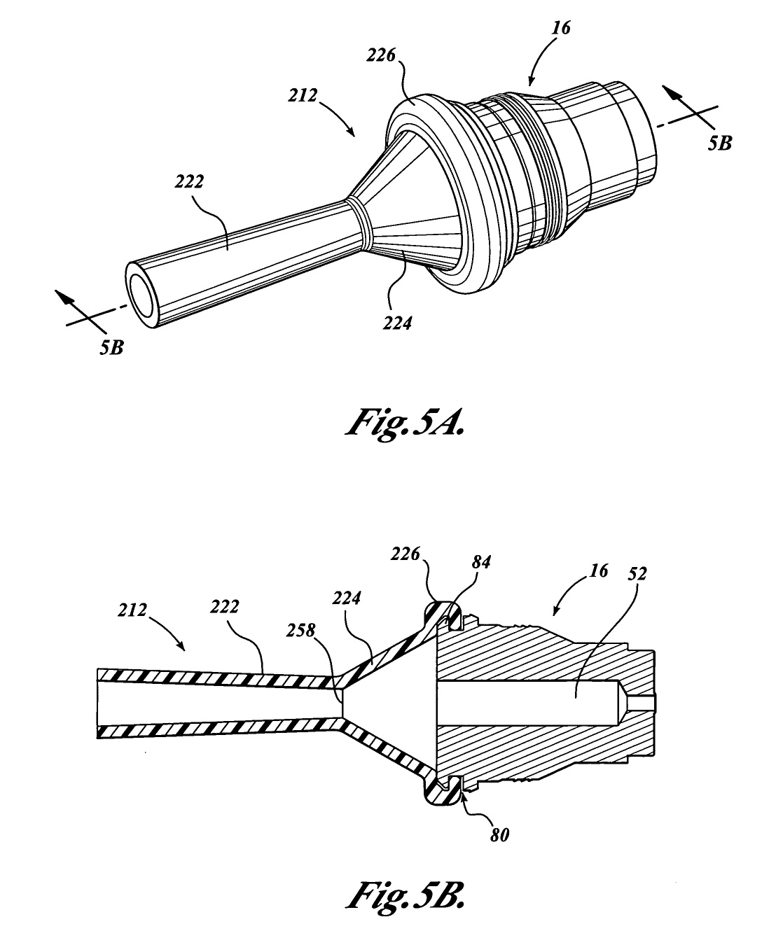

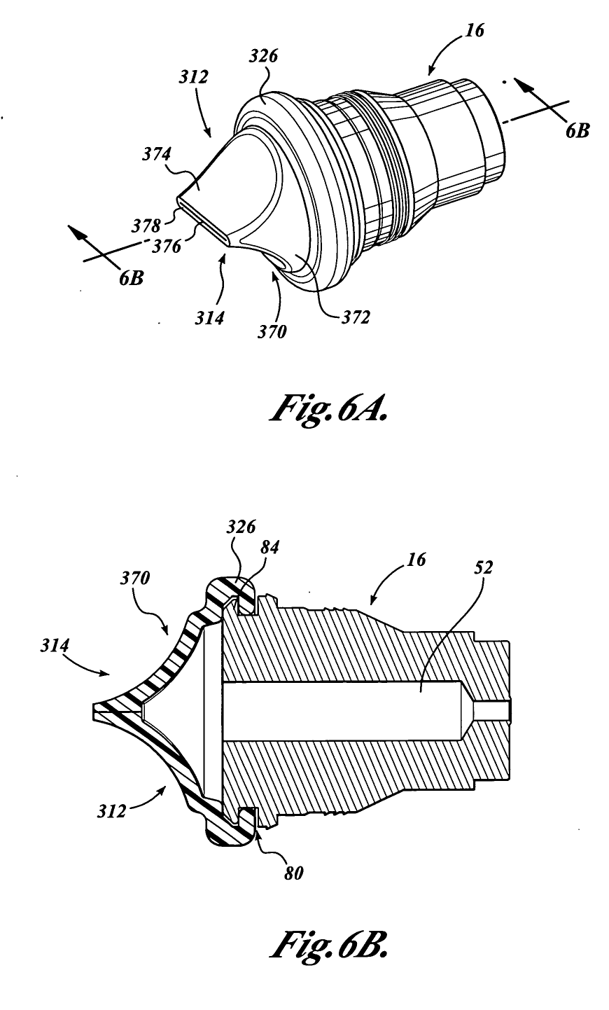

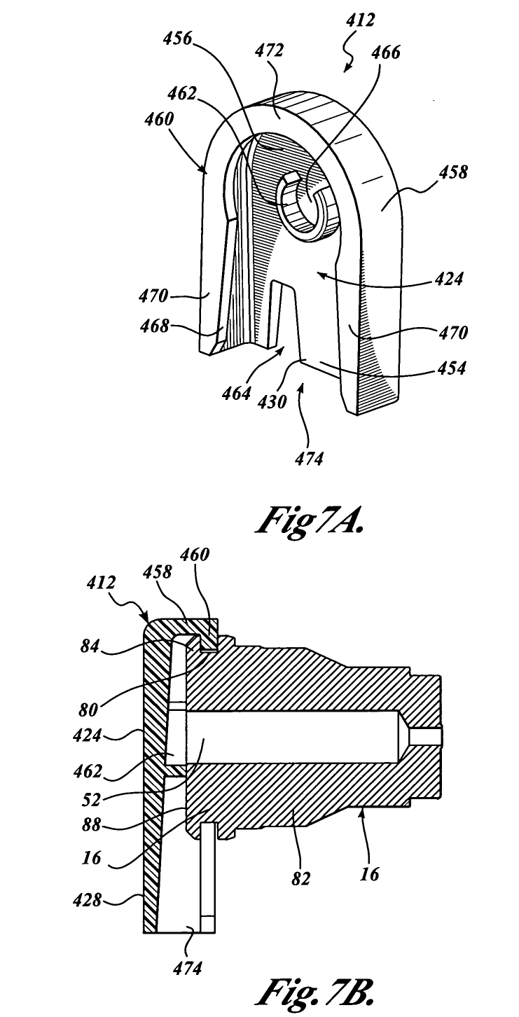

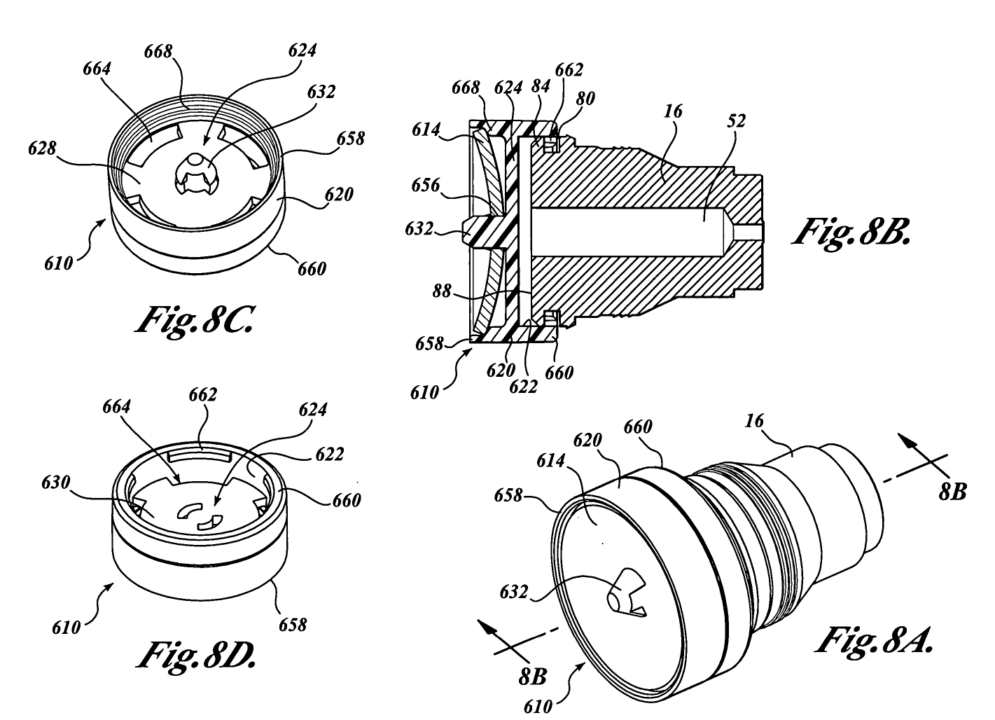

Now referring to FIGS. 5A and 5B, an alternate embodiment of an exhaust port protective device 212 includes a hollow frusto-conical shaped base 224 having a curved lip 226 formed around the perimeter of the base 224. Coupled to the top of the conical-frustro shaped base 224 is a tapered hollow extension tube 222. The hollow extension tube 222 increases slightly in diameter as the extension tube 222 extends away from the conical-frustro shaped base 224. The interior of the hollow conical-frustro shaped base 224 is in communication with the hollow interior of the extension tube 222. It is preferred but not essential that the conical-frustro shaped base 224 and extension tube 222 are molded as one piece.

The exhaust port protective device 212 is made of flexible rubber or plastic such that the device 212 may be stretched, deformed, bent, etc., as needed. The exhaust port protective device 212 is coupled to the pole piece 16 by stretching the curved lip 226 over the exposed annular projection 84 and into the annular groove 80.

Excess air from the solenoid valve 18 is exhausted through the exhaust port protective device 212 coupled to the exhaust port 50. Air flows through the bore 52 into the hollow interior of the conical-frustro shaped base 224, and thereafter through the extension tube 222. The exhaust port protective device 212 prevents moisture from entering the bore 52 by deflecting the spray of contamination from angles of impingement that would normally allow ingress. When contamination is sprayed at the extension tube 222 at certain angles, the extension tube 222 flexes away from the spray and prevents the ingress of contamination.

Now referring to FIGS. 6A and 6B, an alternate embodiment of an exhaust port protective device 312 includes a one-way valve 314 formed with a curved lip 326. The one-way valve 314 is molded from a flexible rubber material, and it includes a hollow cylindrical body 372 that projects upwardly from the curved lip 326. Two opposing curved slanted walls 374 formed in the hollow cylindrical body 372 converge toward an elongated slit, or valve opening 376 defined by two lips 378. It should be appreciated that the walls 374 need not be curved.

The curved lip 326 is formed along the edge of the valve portion 370 and extends away from the valve portion 370. The curved lip 326 is substantially C-shaped in cross section and made of flexible rubber or plastic such that the lip 326 may be stretched, deformed, bent, etc. as needed. Thus, the exhaust port protective device 312 is coupled to the pole piece 16 by stretching the curved lip 326 over the exposed annular projection 84 and into the annular groove 80.

Excess air from the solenoid valve 18 is exhausted through the exhaust port protective device 312 coupled to the exhaust port 50. As the flow in the solenoid air valve 18 increases, the pressure on the slanted walls 374 and lips 378 increases and the one-way valve 314 opens at the valve opening 376. The exhaust port protective device 312 prevents moisture from entering the valve opening 376 of the one-way valve 314 by deflecting the spray of contamination from angles of impingement that would normally cause the one-way valve 314 to open and allow ingress.

Now referring to FIG. 7A, an alternate embodiment of an exhaust port protective device 412 includes a face cover 424 with a face cover inner surface 430 and a face cover outer surface 428. The face cover 424 includes a rectangular portion 454 and a semicircular portion 456. Preferably, the face cover 424 tapers in thickness at the rectangular portion end of the face cover 424. An annular projection 462 is formed on the face cover inner surface 430 in approximately the center of the semicircular portion 456. The annular projection 462 has an opening 466 in the upper portion of the annular projection 462. The face cover 424 also includes an air slot 464 formed in the rectangular portion 454 of the face cover 424 and along the bottom edge of the face cover 424. The air slot 464 is preferably offset from the center of the bottom edge of the face cover 424, on either side of the face cover 424.

Extending substantially orthogonally from the face cover inner surface 430 and around the perimeter of the face cover 424 is a wall 458. A flange 460 is formed along the wall 458 which includes two straight portions 470 and a curved portion 472. The straight portion 470 of flange 460 tapers in width near the bottom of the straight portion 470 to form a tapered edge 468. The area defined by the rectangular portion 454 of the face cover 424, the wall 458, and the straight portion 470 of the flange 460 forms a bottom opening 474.

Referring to FIG. 7B, the exhaust port protective device 412 is coupled to the pole piece 16 by sliding the flange 460 within the annular groove 80. The tapered edge 468 of flange 460 slides along the annular groove 80 until the pole piece 16 is received within the curved portion 472 of flange 460. With the pole piece 16 received within the exhaust port protective device 412, the annular projection 462 engages the end surface 88 of the pole piece 16 to partially surround the opening of the central bore 52. At the same time, the bottom of the exhaust port protective device 412 is suspended out in front of and below the pole piece 16.

The excess air from the solenoid valve 18 is exhausted through the bore 52 and then through the annular projection opening 466 of the annular projection 462. The air then exits the exhaust port protective device 412 through the air slot 464 and the bottom opening 474. The exhaust port protective device 412 prevents moisture from entering the central bore 52 by deflecting the spray of contamination directly into the central bore 52. Moreover, if contamination enters the face cover 424 through the air slot 464 or bottom opening 474, the contamination does not enter the central bore 52 unless it reaches the annular projection opening 466.

Now referring to FIG. 8A-8D, an alternate embodiment of an exhaust port protective device 610 includes a hollow cylindrical housing 620 having a housing top edge 658 and a housing bottom edge 660. A circular base 624 having a base inside surface 630 and a base outside surface 628 and having substantially the same size and circular shape as the hollow portion of the cylindrical housing 620 is disposed within the hollow portion of the cylindrical housing 620. The base 624 is positioned within the housing 620 such that it is substantially equidistant from the housing top edge 658 and the housing bottom edge 660. The circular base 624 includes plurality of curved slots 664 spaced circumferentially about the base perimeter, each curved slot 664 conforming to the circular shape of the base 624. Preferably, four slots 664 are formed within the base 624 and are spaced equidistant from one another. A barbed projection 632 is formed in the center of the base 624 and projects outwardly from the base outside surface 628.

A plurality of curved elongated tabs 662 are formed along the housing bottom edge 660. Preferably, four tabs 662 are formed along the housing bottom edge 660 and are spaced equidistant from one another. Moreover, the inside surface 22 of the housing 620 includes a circular shoulder 668 near the top edge 658 of the housing 620.

A rubber disc 614 with a central opening 656 is received within the housing 620. The rubber disc 614 may be deformed, bent, etc., as needed to be received within the housing 620. The rubber disc 614 is received within the housing 620 by deforming the disc 614 to engage the barbed projection 632. The barbed projection 632 passes through the central opening 656 of the rubber disc 614 as the disc 614 is flexed downward in the middle of the disc 614 to be received within the housing 620.

Although the center of the rubber disc 614 is flexed downward toward the base 624, the circular edge of the rubber disc 614 is retained near the housing top edge 658 by the circular shoulder 668. The edge of the rubber disc 614 is held in tension against the shoulder 668 when the middle of the disc 614 is flexed downward such that the disc 614 has an arcuate shape in cross-section.

The exhaust port protective device 610 is coupled to the pole piece 16 by urging the tabs 662 over the exposed annular projection 84 and into the annular groove 80. The tabs 662 are tapered to reduce the force needed to urge the tabs 662 into the annular groove 80; however, once the exhaust port protective device 610 is coupled to the pole piece 16, it cannot easily be removed.

The excess air from the solenoid valve 18 is exhausted through the exhaust port protective device 610 coupled to the exhaust port 50. In zero flow conditions the edge of the disc 614 remains abutted to the shoulder 668. As the flow in the solenoid air valve 18 increases, the pressure on the disc 614 also increases and the edge of the disc 614 is lifted away from the shoulder 668, allowing air to escape. The exhaust port protective device 610 prevents contamination from entering the exhaust port 50 because the disc 614 deflects the spray of contamination from angles of impingement that would normally allow ingress.

While illustrative embodiments have been illustrated and described, it will be appreciated that various changes can be made therein without departing from the spirit and scope of the application.

The embodiments of the application in which an exclusive property or privilege is claimed are defined as follows:

1. In a valve assembly of the type having a housing, a pole piece disposed within the housing, and an exhaust port, an exhaust port protective device, comprising:
a flow restrictor assembly coupled at least in part to the pole piece, the flow restrictor assembly providing fluid flow in a first direction and restricting fluid flow in a second direction.

2. The exhaust port protective device of claim 1, wherein the flow restrictor assembly is a one-way valve substantially configured as a flexible cone-shaped device having a centrally located opening.

3. The exhaust port protective device of claim 2, wherein the flow restrictor assembly includes a hollow tube, and the one-way valve is at least partially disposed within the hollow tube.

4. The exhaust port protective device of claim 1, wherein the flow restrictor assembly comprises:
(a) a frusto-conical-shaped device having a hollow interior, the frusto-conical-shaped device being coupled to the pole piece; and
(b) a tube having a hollow interior and coupled to the frusto-conical-shaped device, wherein the hollow interior of the tube is in fluid communication with the hollow interior of the frusto-conical-shaped device.

5. The exhaust port protective device of claim 1, wherein the flow restrictor assembly comprises:
(a) a face cover;
(b) a wall formed partially around the perimeter of the face cover, wherein the wall defines an air gap between the face cover and the pole piece when the exhaust port protective device is mounted to the pole piece.

6. The exhaust port protective device of claim 1, wherein the flow restrictor comprises:
(a) a hollow cylindrical housing with open ends, the housing coupled to the pole piece;
(b) a circular base disposed within the hollow cylindrical housing;
(c) a retention device coupled to the circular base; and
(d) a circular disc retained within the hollow cylindrical housing by the retention device.

7. In a valve assembly of the type having a housing, a pole piece disposed within the housing, and an exhaust port, an exhaust port protective device, comprising:
(a) an extension assembly coupled to the pole piece; and
(b) a flow restrictor assembly coupled to the extension assembly, the flow restrictor assembly configured to permit fluid flow in a first direction and resisting fluid flow in a second direction.

8. The exhaust port protective device of claim 7, wherein the flow restrictor assembly is a one-way valve substantially configured as a flexible cone-shaped device having a centrally located opening.

9. The exhaust port protective device of claim 8, wherein the extension assembly is an exhaust shield cover and a hollow extension tube coupled thereto, wherein the one-way valve is at least partially received within the hollow extension tube.

10. The exhaust port protective device of claim 7, wherein the flow restrictor assembly comprises a frusto-conical-shaped device having a hollow interior.

11. The exhaust port protective device of claim 10, wherein the extension assembly is a flexible extension tube having a hollow interior, and the flexible extension tube is coupled to the frusto-conical-shaped device such that the hollow interior of the flexible extension tube is in fluid communication with the hollow interior of the frusto-conical-shaped device.

12. In a valve assembly of the type having a housing, a pole piece disposed within the housing, and an exhaust port, an exhaust port protective device, comprising:
(a) an exhaust shield cover with an aperture formed therein;
(b) an extension tube with a hollow interior coupled to the exhaust shield cover, wherein the hollow interior of the extension tube is in fluid communication with the aperture; and
(c) a one-way valve coupled to the exhaust shield cover and in communication with the aperture, the one-way valve at least partially disposed within with the hollow interior of the extension tube.

13. The exhaust port protective device of claim 12, the exhaust shield cover further comprising a base and an annular protrusion, the base having an inner surface and an outer surface, and the annular protrusion formed along the perimeter of the base portion and extending substantially orthogonally from the inner surface of the base portion.

14. The exhaust port protective device of claim 12, the exhaust shield cover further comprising a plurality of slots spaced circumferentially about the aperture.

15. The exhaust port protective device of claim 13, the one-way valve further comprising a valve portion and a flange coupled thereto, the one-way valve engaging the exhaust shield cover such that the valve portion extends at least partially through the hollow interior of the extension tube and the flange portion abuts the base.

16. The exhaust port protective device of claim 13, further comprising at least two tabs formed on the annular protrusion for securing the exhaust port protective device to the air valve.

17. The exhaust port protective device of claim 12, wherein the air valve is a solenoid air valve.
